(19) United States
(12) Patent Application Publication
(10) Pub. No.: US 2026/0249448 A1
(43) Pub. Date: Aug. 27, 2026

(54) DRIVE DEVICE AND ROBOT EQUIPPED WITH DRIVE DEVICE

(71) Applicant: FANUC CORPORATION, Yamanashi (JP)

(72) Inventors: Hidetoshi UEMATSU, Yamanashi (JP); Keitarou INAGAKI, Yamanashi (JP); Taichi TAGUCHI, Yamanashi (JP)

(21) Appl. No.: 18/878,076

(22) PCT Filed: Jul. 14, 2022
(86) PCT No.: PCT/JP2022/027729

§ 371 Date: Dec. 23, 2024

(51) Int. Cl. B25J 9/12; B25J 13/08; H02K 5/22; H02K 7/08; H02K 7/102; H02K 7/116; H02K 11/33

(52) U.S. Cl. CPC B25J 9/126; B25J 13/085; B25J 13/088; H02K 5/225; H02K 7/083; H02K 7/1023; H02K 7/116; H02K 11/33

(57) ABSTRACT

This drive device comprises: an electric motor unit that includes an electric motor; and an amplifier that supplies current to the electric motor. The amplifier includes a plurality of electrical components that are fixed to a substrate. The amplifier is fixed coaxially to an end section of the electric motor unit in the direction of the rotating shaft of the electric motor. The amplifier is formed so as to be capable of being detached from the electric motor unit through manipulation by a worker.

### RELATED APPLICATIONS

The present application is a National Phase of International Application No. PCT/JP2022/027729 filed Jul. 14, 2022.

### TECHNICAL FIELD

The present invention relates to a drive device and a robot including the drive device.

### BACKGROUND ART

In the related art, a drive device that supplies a rotational force of an electric motor to another member is known. The drive device may include an electric motor, a decelerator that amplifies the rotational force of the electric motor, a brake, and the like. A current generated based on a predetermined command is supplied to the electric motor of the drive device. The current supplied to the electric motor is generated by an amplifier. For example, the amplifier is arranged inside a controller separate from the drive device. The controller is capable of supplying a current to the electric motor of the drive device through a cable. Alternatively, a drive device including an amplifier in addition to the electric motor and the decelerator is known (e.g., Japanese Unexamined Patent Publication No. 2010-41747 A).

The drive device may be arranged in a robot device, while the robot device may be provided with a robot including a joint where an orientation of a component such as an arm changes. The robot device can perform operations while changing the position and orientation of operation tools by driving the components of the robot. When the robot includes the joint, the drive device for moving the components is arranged in the joint. The drive device may be arranged for each joint (e.g., Japanese Unexamined Patent Publication No. 2019-84607 A).

### CITATION LIST

### Patent Literature

PTL 1: Japanese Unexamined Patent Publication No. 2010-41747 A
PTL 2: Japanese Unexamined Patent Publication No. 2019-84607 A

### SUMMARY OF INVENTION

### Technical Problem

The drive device may be arranged in any machine. Further, the amplifier can be arranged for each electric motor. In this case, the amplifier fails more frequently than the decelerator, electric motor, and brake. It is preferable that the drive device has a structure with which the amplifier can be easily replaced when the amplifier fails. In other words, it is preferable to use a structure with which the amplifier can be easily removed from the drive device. With the known drive devices, however, it is difficult to remove only the amplifier from the drive device fixed to the machine.

For example, the drive device may be provided with a secondary encoder that detects the rotation position of the output shaft of the decelerator in addition to a primary encoder that detects the rotation position of the electric motor. The secondary encoder is connected to a member related to the output of the decelerator. For example, the secondary encoder is arranged at the endmost portion of the drive device so as to detect the rotation position of a member that rotates together with the output shaft of the decelerator. On the other hand, the amplifier is arranged inside the drive device. To remove the amplifier, the drive device is required to be disassembled after detaching the entire drive device from the machine. As such, it is impossible to remove only the amplifier from the drive device fixed to the machine.

### Solution to Problem

A drive device according to an aspect of the present disclosure includes an electric motor unit including an electric motor, and an electric motor control unit configured to supply a current to the electric motor. The electric motor unit includes at least one device selected from a group of a decelerator, a brake, and a rotation position detector. The electric motor control unit includes a substrate and a plurality of electric components fixed to the substrate. The electric motor control unit is coaxially fixed to an end portion of the electric motor unit in a direction of a rotation axis of the electric motor. The electric motor control unit is formed so as to be detachable from the electric motor unit through an operation by an operator.

A robot of the present disclosure includes the above-described drive device, and a joint configured to rotate one component of the robot with respect to another component of the robot. The drive device is arranged at the joint.

### Advantageous Effects of Invention

According to an aspect of the present disclosure, it is possible to provide a drive device and a robot including the drive device with which an electric motor control unit can be easily detached from a drive device.

### BRIEF DESCRIPTION OF DRAWINGS

FIG. 1 is a perspective view of a robot according to an embodiment.

FIG. 2 is a schematic sectional view of a drive device of the embodiment.

FIG. 3 is an electric circuit diagram of an amplifier according to the embodiment.

FIG. 4 is a schematic perspective view of the amplifier.

FIG. 5 is a schematic plan view of the amplifier.

FIG. 6 is an enlarged schematic sectional view of a joint of a robot where the drive device is arranged.

FIG. 7 is an enlarged schematic sectional view of a joint including a drive device including an amplifier of a comparative example.

### DESCRIPTION OF EMBODIMENTS

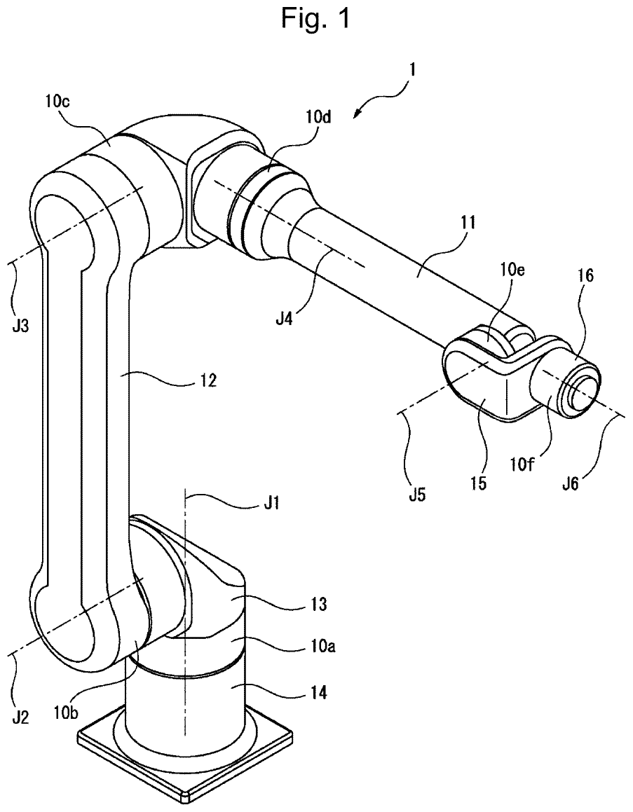

With reference to FIG. 1 to FIG. 7, a drive device and a robot including the drive device of an embodiment are described below. The drive device of the present embodiment is arranged in a joint of the robot. The joint rotates one component of the robot with respect to another component around a predetermined rotation axis.

FIG. 1 is a perspective view of a robot of the present embodiment. A robot 1 of the present embodiment is an articulated robot including a plurality of joints 10a to 10f. The robot 1 of the present embodiment is a cooperative robot that can operate in conjunction with the operator. The cooperative robot is configured such that when a predetermined external force acts on the robot 1, the operation of the robot 1 is limited.

The robot 1 includes a plurality of components that are rotatable at the joints 10a to 10f. The components are formed so as to rotate around drive axes J1 to J6 serving as the rotation axes. The drive device of the present embodiment is arranged inside the joints 10a to 10f so as to drive the components of the robot 1. The robot of the present embodiment has six drive axes, but is not limited to this configuration. Robots that change the position and orientation with given mechanisms may be employed.

The robot 1 of the present embodiment includes, as the components of the robot 1, a base part 14, a turning base 13, an upper arm 12, a front arm 11, and a wrist 15. The turning base 13 rotates around the drive axis J1 with respect to the base part 14 fixed to the installation surface. The upper arm 12 rotates around the drive axis J2 with respect to the turning base 13. The front arm 11 rotates around the drive axis J3 with respect to the upper arm 12. Further, the front arm 11 rotates around the drive axis J4 that is parallel to the extending direction of the front arm 11. The robot 1 includes the wrist 15 supported by the front arm 11. The wrist 15 rotates around the drive axis J5. In addition, the wrist 15 includes a flange 16 that rotates around the drive axis J6. An operation tool corresponding to the operation performed by the robot device is fixed to the flange 16.

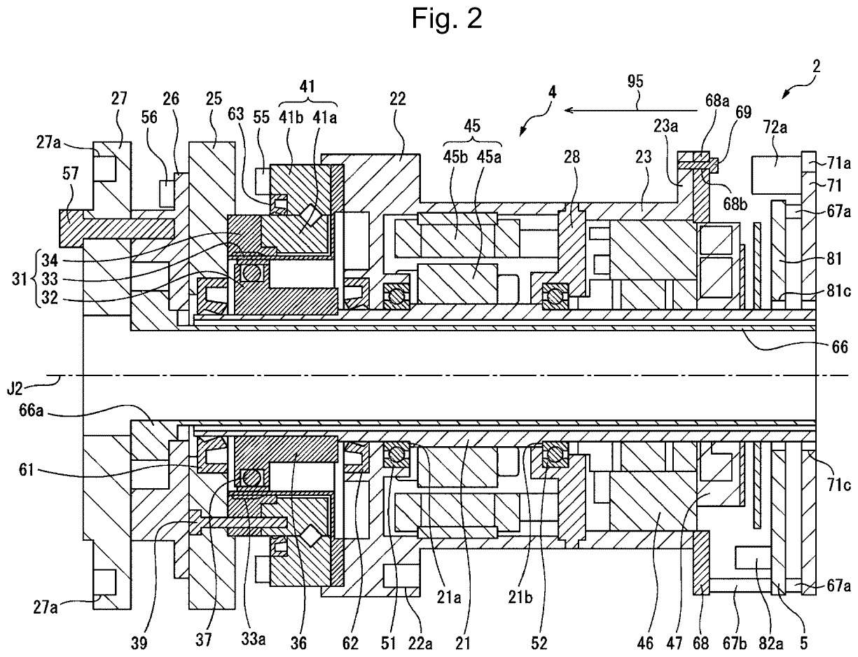

FIG. 2 is a sectional view of the drive device of the present embodiment. With reference to FIG. 1 and FIG. 2, in the robot 1 of the present embodiment, a drive device is arranged for each of the joints 10a to 10f. In other words, one drive device is arranged for each joint. In the present embodiment, the drive device 2 for rotating the upper arm 12 around the drive axis J2 with respect to the turning base 13 is described as an example. The drive device 2 is arranged at the joint 10b. The drive device 2 is arranged such that the direction indicated by an arrow 95 is the direction toward the turning base 13, for example.

The drive device 2 includes an electric motor 45 including a rotor 45a and a stator 45b. The drive axis J2 corresponds to the rotation axis of the electric motor 45 and the axial direction of the drive device 2. The rotor 45a is fixed to a shaft 21. The shaft 21 that transmits the rotational force of the electric motor 45 serves as an output shaft of the electric motor 45. The shaft 21 of the present embodiment is a hollow shaft having a cylindrical shape. The shaft 21 rotates with the drive axis J2 as a rotation axis.

The drive device 2 includes a torque sensor 27 that detects a torque output from the drive device 2. The torque sensor 27 detects a torque around the drive axis J2 when the drive device 2 is driven. The robot device includes the robot 1 and a robot controller that controls the robot 1. The robot controller receives a signal related to a torque through a communication cable serving as a communication line. The robot controller subtracts the moment related to the own weight of the robot and the moment related to the operation of the robot from the torque detected at the torque sensor. The calculated moment corresponds to the external force applied to the robot.

The robot of the present embodiment is a cooperative robot. When the external force is greater than a predetermined determination value, the robot controller can limit the operation of the robot. For example, when the operator touches the robot, the external force to be detected increases. The robot controller can stop the robot when the external force becomes greater than a determination value. The drive device of the present embodiment includes the torque sensor, but is not limited to this configuration. The torque sensor need not be arranged in the drive device.

A flange 26 is fixed to the torque sensor 27 with a bolt 57. A flange 25 is fixed to the flange 26 with a bolt 56. In the present embodiment, the torque sensor 27 and the flanges 25 and 26 are fixed to the housing of the turning base 13.

The drive device 2 includes an electric motor unit 4 including the electric motor 45. The electric motor unit 4 may include at least one device selected from a group of a decelerator, a brake, and a rotation position detector. The devices are arranged coaxially in the direction along the rotation axis of the electric motor 45. The electric motor unit 4 of the present embodiment includes a decelerator 31 that amplifies the rotational force of the electric motor 45, an electromagnetic brake 46 serving as a brake for the shaft 21, and an encoder 47 serving as a rotation position detector that detects the rotation position of the output shaft of the electric motor 45. The torque sensor 27, the decelerator 31, the electric motor 45, the electromagnetic brake 46, and the encoder 47 are arranged in a row in this order. It should be noted that at least one selected from the group of the decelerator, the electromagnetic brake, and the encoder need not be arranged in the electric motor unit.

The drive device 2 includes a housing 22 with the electric motor 45 arranged inside. The housing 22 of the present embodiment is fixed to the housing of the upper arm 12. The shaft 21 is supported at bearings 51 and 52 in a rotatable manner. The drive device 2 includes a housing 23 with the electromagnetic brake 46 arranged inside. The housing 22 and the housing 23 are fixed to each other with a fastening member such as a bolt. In addition, a bearing fixing member 28 for fixing the bearing 52 is arranged between the housing 22 and the housing 23. The bearing fixing member 28 is fixed to the housing 23 with a fastening member such as a bolt. The housings 23 and 22 and the bearing fixing member 28 can be detached from the side opposite to the direction indicated by the arrow 95 by detaching the fastening member.

A protective tube 66 is arranged at an inner side of the shaft 21. The protective tube 66 is formed in a cylindrical shape along the inner surface of the shaft 21. A wire body such as an electric wire such as a power cable, an air tube that supplies compression air, or a communication cable is inserted inside the protective tube 66. The protective tube 66 is fixed with a nipping portion 66a sandwiched by the flange 26 and the torque sensor 27. When the protective tube 66 is arranged, the wire body can be arranged inside the joint 10b of the robot 1.

The shaft 21 of the present embodiment includes a step part 21 a and a step part 21b for restricting the movement in the extending direction of the rotation axis of the shaft 21. The bearings 51 and 52 are engaged with the step part 21a and the step part 21b. The bearing 51 is fixed by the housing 22, and the bearing 52 is fixed by the bearing fixing member 28.

The decelerator 31 of the drive device 2 transmits the rotational force output by the electric motor 45 to the housing 22. The decelerator 31 of the present embodiment is a wave gear decelerator. The decelerator 31 includes a wave generation member 32 serving as an input part where the rotational force is input. The wave generation member 32 is referred to as a wave generator. The wave generation member 32 includes a hub 36 whose shape (planar shape) as viewed from the direction of the rotation axis is an ellipse shape, and a ball bearing 37 arranged at the outer peripheral surface of the hub 36. The hub 36 serves as a cam having an ellipse planar shape. The hub 36 is fixed to the shaft 21 by means of key coupling or the like, for example.

The decelerator 31 includes an elastic cylindrical member 33 that is elastically deformable. The elastic cylindrical member 33 is referred to as a flexspline. The elastic cylindrical member 33 includes a plurality of first tooth parts 33a formed at the outer peripheral surface. The elastic cylindrical member 33 is formed so as to deform along with the rotation of the hub 36. The elastic cylindrical member 33 of the present embodiment is fixed to the housing 22 with a bolt 55. The elastic cylindrical member 33 serves as the output shaft of the decelerator 31.

The decelerator 31 includes an annular member 34 arranged at an outer side of the elastic cylindrical member 33. The annular member 34 is referred to as a circular spline. The annular member 34 is composed of a rigid member that does not elastically deform. A second tooth part that engages with the first tooth part 33a is formed at the inner peripheral surface of the annular member 34.

A main bearing 41 is arranged on the lateral side of the annular member 34. The main bearing 41 of the present embodiment is a cross roller bearing. The main bearing 41 includes an inner ring 41a and an outer ring 41b. The inner ring 41a is fixed to the flange 25 and the annular member 34 with a bolt 39. The outer ring 41b is fixed to the elastic cylindrical member 33 together with the housing 22 with the bolt 55. In the present embodiment, the wave generation member 32 rotates, but the annular member 34 is fixed so as not to rotate. When disassembling the drive device 2, the bolts 56 and 57 are detached so as to detach the torque sensor 27 and the flange 26 from the flange 25. By detaching the bolt 39 and the bolt 55, the decelerator 31 and the main bearing 41 can be detached from the housing 22.

The hub 36 of the wave generation member 32 has an elliptical shape, and thus the first tooth part 33a of the elastic cylindrical member 33 and the second tooth part of the annular member 34 engage with each other in the major axial direction of the ellipse. In this regard, the number of teeth of the first tooth part 33a of the elastic cylindrical member 33 is smaller than the number of teeth of the second tooth part of the annular member 34. For example, the numbers of the teeth differ by two. When the wave generation member 32 rotates one revolution, the elastic cylindrical member 33 slightly rotates by a reduction ratio corresponding to the difference in the number of teeth of the tooth part.

The decelerated rotational force is output to the housing 22 and the outer ring 41b of the main bearing 41 fixed to the elastic cylindrical member 33. The housing 22 of the drive device 2 is fixed to the housing of the upper arm 12. In this manner, when the drive device 2 is driven, the upper arm 12 rotates with respect to the turning base 13.

Oil seals 61 and 62 are arranged at the outer peripheral surface of the shaft 21 such that the lubricating oil inside does not leak to the outside, or that entry of foreign matters from the outside is prevented. In addition, an oil seal 63 is arranged such that the lubricating oil inside the main bearing 41 does not leak to the outside, or that entry of foreign matters from the outside is prevented.

The drive device 2 of the present embodiment includes an amplifier 5 serving as an electric motor control unit that supplies current to the electric motor 45. The amplifier 5 is also referred to as a driver for driving the electric motor 45. The amplifier 5 of the present embodiment is fixed to an end portion of the electric motor unit 4 in the axial direction. In particular, the amplifier 5 is coaxially fixed to an end surface of the electric motor unit 4. The amplifier 5 is arranged at the endmost among the components included in the drive device 2. The amplifier 5 is arranged coaxially with the electric motor unit 4 including the electric motor 45. The torque sensor 27 is arranged at an end portion on the side opposite to one end portion of the electric motor unit 4 where the amplifier 5 is arranged.

The amplifier 5 of the present embodiment receives operation commands from the robot controller, and controls the value and frequency of the current to be supplied to the electric motor 45 based on the operation command. The amplifier 5 includes an electric circuit that generates the current to be supplied to the electric motor 45. In the drive device of the present embodiment, the amplifier 5 is arranged for each electric motor. One amplifier 5 is arranged for each electric motor 45, but is not limited to this configuration. One amplifier may be arranged for a plurality of electric motors. In other words, an amplifier that supplies a current to a plurality of electric motors may be arranged.

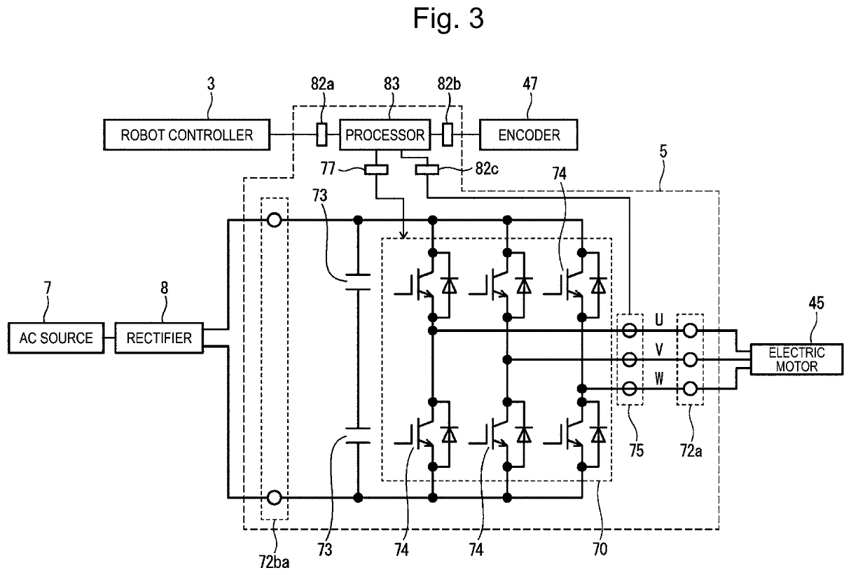

FIG. 3 is an electric circuit diagram illustrating the amplifier of the present embodiment. The robot controller 3 is arranged away from the robot 1, for example. The robot controller 3 includes a computation processing device including a CPU (Central Processing Unit) serving as a processor. The robot controller 3 outputs operation commands to the drive devices arranged in the joints 10a to 10f. The AC current from the AC source 7 is converted to DC current by a rectifier 8. The amplifier 5 of the present embodiment serves as an inverter that converts the DC current from the rectifier 8 to the AC current.

The amplifier 5 includes a capacitor 73 for smoothening the DC current. The amplifier 5 includes a main circuit 70 that generates a 3-phase AC current from the DC current. The main circuit 70 is a bridge circuit including a power element 74 such as a MOSFET (Metal-Oxide-Semiconductor Field-Effect Transistor). The amplifier 5 includes a processor 83 such as an MCU (Micro Controller Unit) that outputs operation commands to each power element 74 of the main circuit 70.

The processor 83 receives the operation command for driving the electric motor 45 from the robot controller 3. The processor 83 receives the output signal of the encoder 47 that detects the rotation position of the electric motor 45. In addition, a current detection sensor 75 is arranged at the power cable output from the main circuit 70. The processor 83 receives the output signal of the current detection sensor 75.

The processor 83 outputs a switching command to the main circuit 70 on the basis of the operation command from the robot controller 3. The processor 83 may output commands for controlling the power element 74 on the basis of the output signal of the encoder 47, the output signal of the current detection sensor 75, and the output signal of the torque sensor 27. The plurality of electric components such as the processor 83, the capacitor 73, and the power element 74 is arranged on the surface of the substrate included in the amplifier 5.

The drive device 2 of the present embodiment includes a wire body for connecting to an external device. The wire body includes a power cable for supplying electricity and a communication cable for transmitting signals. The wire body of the present embodiment includes a connecting member arranged at a distal end of the cable for connecting to the substrate. The connecting member of the wire body is connected to the substrate member.

The connecting member of the wire body of the present embodiment is composed of a connector. A connector that fits with the connector of the wire body is arranged on the substrate of the amplifier. For example, a female connector is arranged on the substrate. The male connector arranged at a distal end of the wire body is inserted or removed. In this manner, the connector of the wire body is formed such that it is attached to the connector of the substrate of the amplifier, or detached to the connector of the substrate by the operator.

The connecting member of the wire body is not limited to the connector, and any member that can be attached to the members of the substrate of the amplifier or detached from the members of the substrate may be employed. For example, a crimp terminal may be employed as the connecting member of the wire body. A terminal base for attaching the crimp terminal with a screw may be arranged on the substrate.

With the wire body including the connecting member formed for attaching to the members of the substrate of the amplifier or detaching from the members of the substrate, the wire body can be easily detached from or attached to the substrate. As a result, the amplifier can be easily separated from the robot or the electric motor unit, or fixed to the robot or the electric motor unit.

The command from the robot controller 3 is input to the processor 83 through a connector 82a arranged at the substrate. The output signal of the encoder 47 is input to the processor 83 through the connector 82b. The output signal of the current detection sensor 75 is input to the processor 83 through a connector 82c. The command output from the processor 83 is output to the main circuit 70 through a terminal 77.

In addition, the current converted to the direct current at the rectifier 8 is input to the main circuit 70 through a connector 72ba arranged on the substrate. Further, U-phase, V-phase, and W-phase AC currents supplied from the main circuit 70 are supplied to the electric motor 45 through a connector 72a arranged on the substrate.

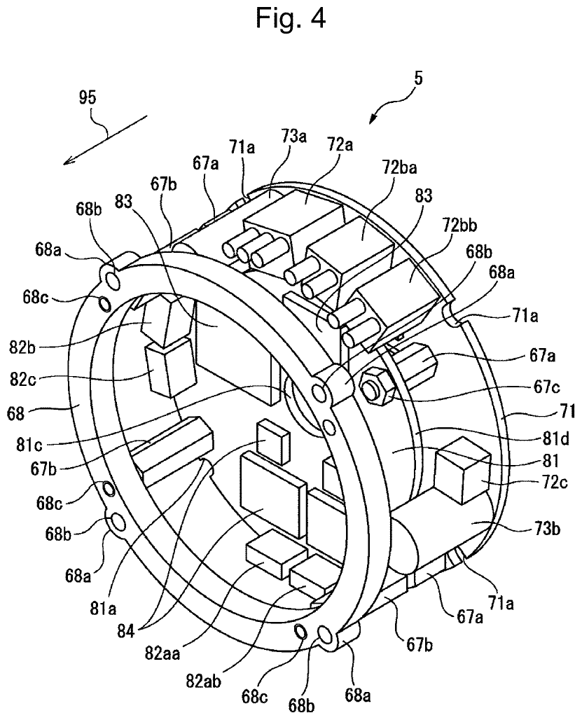

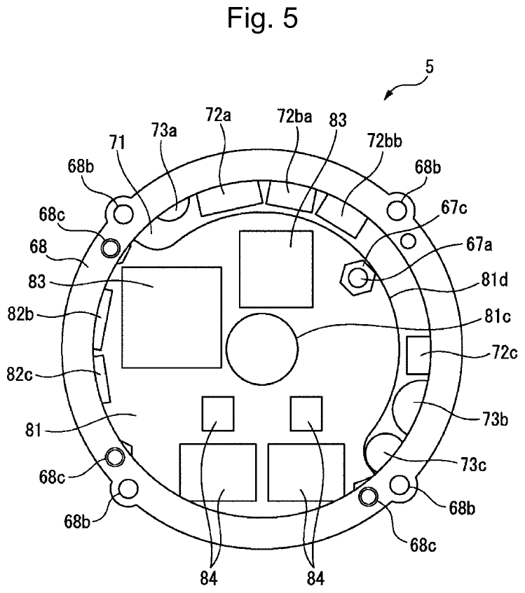

FIG. 4 is a perspective view of the amplifier of the present embodiment. FIG. 5 is a schematic plan view of the amplifier of the present embodiment. With reference to FIG. 2 to FIG. 5, the arrow 95 indicates a direction in which the electric motor 45 is arranged with respect to the amplifier 5. The arrow 95 indicates a direction along the drive axis J2 as the rotation axis of the electric motor 45.

The amplifier 5 of the present embodiment includes two substrates where electric components are arranged. The amplifier 5 includes a power substrate 71 where an electric component for supplying power to the electric motor 45 is arranged. The amplifier 5 includes a control substrate 81 where electric components for generating command signals for controlling the main circuit 70 are arranged. The power substrate 71 and the control substrate 81 are each arranged so as to intersect the extending direction of the drive axis J2.

In the present embodiment, the power substrate 71 and the control substrate 81 each have a maximum area surface with the maximum area. The plurality of electric components are arranged in the maximum area surface. The power substrate 71 and the control substrate 81 are arranged such that the maximum area surfaces perpendicularly intersect the drive axis J2. In addition, the power substrate 71 and the control substrate 81 are arranged such that the maximum area surfaces are parallel to each other.

In the amplifier of the present embodiment, the substrate where the electronic component is arranged is composed of the power substrate and the control substrate, but is not limited to this configuration. The number of the substrate where the electronic component is arranged may be one. Alternatively, three or more substrates may be arranged.

The control substrate 81 is fixed to the power substrate 71 with an interval bolt 67a. One interval bolt 67a fixes the control substrate 81 with a nut 67c. Another interval bolt 67a fixes the control substrate 81 by sandwiching the control substrate 81 with it and an interval bolt 67b. The control substrate 81 is fixed to the metal fitting 68 with the interval bolt 67b. The control substrate 81 is sandwiched by the interval bolt 67a and the interval bolt 67b.

The metal fitting 68 is formed in an annular shape. The metal fitting 68 is a member for fixing the amplifier 5 to the housing 23 of the electric motor unit 4. The metal fitting 68 includes a screw hole 68c for fixing the interval bolt 67b. In the present embodiment, the power substrate 71, the control substrate 81, and the metal fitting 68 are integrally fixed with the interval bolts 67a and 67b. The method of fixing the plurality of substrates is not limited to this embodiment, and they may be fixed to each other with any members.

The amplifier 5 of the present embodiment is formed so as to be detachable from the electric motor unit 4 through the operator's operation, and the metal fitting 68 includes a protrusion 68a protruding outward in the radial direction. A hole 68b for inserting the bolt 69 serving as a fastening member is formed in the protrusion 68a. With reference to FIG. 2, a protrusion 23a protruding outward in the radial direction is formed at an end portion of the housing 23 of the electric motor unit 4. A screw hole is formed in the protrusion 23a. The protrusion 68a of the metal fitting 68 is fixed to the protrusion 23a of the housing 23 with the bolt 69. In this manner, the amplifier 5 is directly fixed to the end portion of the electric motor unit 4 with the bolt 69. The operator can detach the amplifier 5 from the drive device 2 by detaching the bolt 69.

A through hole 71c is formed at a center portion of the power substrate 71. In addition, a through hole 81c is formed at a center portion of the control substrate 81. The shaft 21 and the protective tube 66 are inserted in the through holes 71c and 81c.

With reference to FIG. 2 to FIG. 5, capacitors 73a, 73b and 73c with a function of smoothening DC current are arranged on the power substrate 71. The connector 72a for supplying current to the electric motor 45 is arranged on the power substrate 71. The connector 72ba to which a power cable 86a for receiving the current from the rectifier 8 is connected is arranged on the power substrate 71. A connector 72bb to which a power cable 86b for supplying the power to other drive devices is connected is arranged on the power substrate 71. In addition, a connector 72c for supplying the power to the electromagnetic brake 46 is arranged on the power substrate 71.

The plurality of power elements 74 included in the main circuit 70 is arranged in the maximum area surface of the power substrate 71. In addition, the current detection sensor 75 for detecting the current output from the main circuit 70 is arranged. The terminal 77 for performing communications with the electric circuit of the control substrate 81 is arranged on the power substrate 71. The terminal 77 is formed so as to fit with the terminal arranged on the rear surface of the control substrate 81.

The control substrate 81 has a shape that is obtained by cutting out the outer periphery of a part of circular substrate. The control substrate 81 includes a notch 81d. The connectors 72a, 72ba, 72bb and 72c and the capacitors 73a, 73b and 73c of the power substrate 71 are arranged at an outer side of the notch 81d.

The processor 83 that outputs a command to the main circuit 70 is arranged on the control substrate 81. A processing circuit 84 for processing input data is arranged on the control substrate 81. In this regard, the plurality of drive devices of the robot 1 of the present embodiment are formed so as to perform serial communication with each other. One drive device is connected to the other drive device through a communication cable. A connector 82aa to which a communication cable 87a for receiving from the other drive device the signal from the robot controller 3 is connected is arranged on the control substrate 81. A connector 82ab to which a communication cable 87b for transmitting the signal from the robot controller 3 to the other drive device is connected is arranged on the control substrate 81.

In addition, the connector 82b to which a signal cable for receiving the signal from the encoder 47 is connected is arranged on the control substrate 81. In addition, the connector 82c to which a signal cable for receiving the signal from the current detection sensor 75 is connected is arranged. Furthermore, a connector to which a signal cable for receiving the signal from the torque sensor 27 is connected may be arranged.

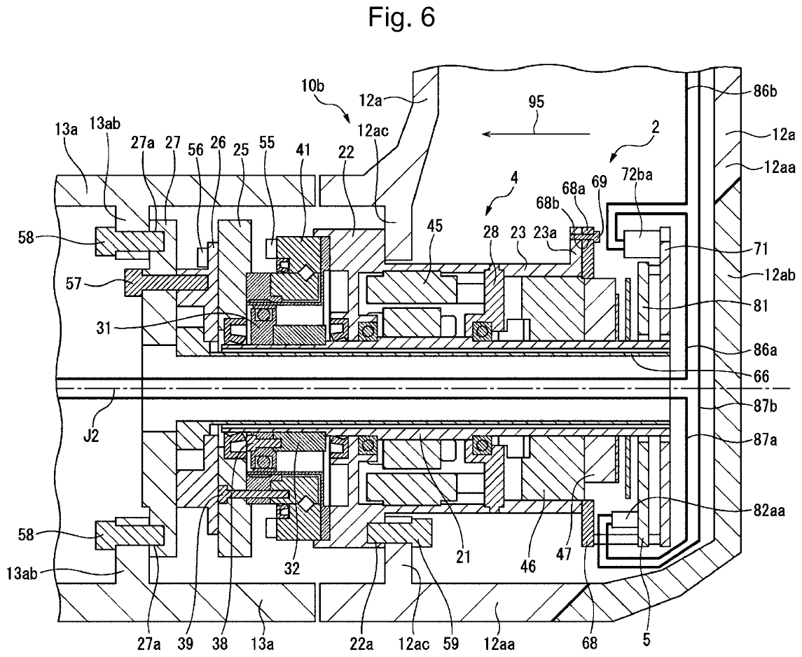

FIG. 6 is an enlarged schematic sectional view of the joint when the drive device of the present embodiment is arranged in the joint of the robot. FIG. 6 is a schematic sectional view of the joint 10b that rotates the upper arm 12 serving as another component with respect to the turning base 13 serving as one component of the robot 1.

With reference to FIGS. 2 and 6, the torque sensor 27 of the drive device 2 includes a screw hole 27a. A protruding part 13ab protruding inward is formed in a housing 13a of the turning base 13. A through hole is formed in the protruding part 13ab. With a bolt 58 inserted through the through hole of the protruding part 13ab and fixed to the screw hole 27a, the torque sensor 27 is fixed to the housing 13a of the turning base 13.

In addition, the housing 22 of the electric motor unit 4 includes a screw hole 22a. The housing 12a of the upper arm 12 includes a protruding part 12ac protruding inward. A through hole is formed in the protruding part 12ac. With a bolt 59 inserted through the through hole and fixed to the screw hole 22a, the housing 22 of the drive device 2 is fixed to the housing 12a of the upper arm 12.

As described above, when the electric motor 45 is driven, the housing 22 of the electric motor unit 4 rotates together with the elastic cylindrical member 33 of the decelerator 31. Further, the housing 12a of the upper arm 12 fixed to the housing 22 of the electric motor unit 4 rotates together with the housing 22. As a result, the upper arm 12 rotates around the drive axis J2 with respect to the turning base 13.

The power cable 86a and the communication cable 87a are inserted inside the protective tube 66. The power cable 86a and the communication cable 87a are connected to the drive device arranged in an adjacent joint 10a. With reference to FIGS. 4 and 6, the power cable 86a is connected to the connector 72ba. Further, the power cable 86b is connected to the connector 72bb. The power cable 86b is connected to the drive device arranged in an adjacent joint 10c.

In the plurality of drive devices of the robot 1 of the present embodiment, the information communicated through the communication cables 87a and 87b for performing mutual serial communication may include, in addition to the operation command, information detected by the sensor arranged in the robot 1. The communication cable 87a is connected to the drive device 2 of the connector 82aa. Further, the communication cable 87b connected to the connector 82ab of the drive device 2 is connected to the drive device of the adjacent joint 10c. In this manner, the drive device 2 is arranged inside the housing of the components of the robot 1.

The housing 12a of the upper arm 12 of the present embodiment includes a body part 12aa and a lid 12ab that is detachable from the body part 12aa. The lid 12ab is fixed to the body part 12aa with a fastening member not illustrated in the drawing.

The lid 12ab is arranged so as to face the drive device 2. The lid 12ab has a size corresponding to the region where the drive device 2 is arranged. The lid 12ab has a shape with which the operator can see the entire end portion of the drive device 2 by detaching the lid 12ab. In the present embodiment, the lid 12ab is formed larger than the drive device 2 in the radial direction. Further, the lid 12ab is formed larger than the end surface of the amplifier 5.

With reference to FIG. 4 to FIG. 6, the power substrate 71 is formed in a substantially circular planar shape. A recess 71a is formed at the outer periphery of the power substrate 71. The recess 71a is formed corresponding to the position of the bolt 69 for fixing the amplifier 5 to the housing 23. In other words, the recess 71a is formed at a position corresponding to the hole 68b of the metal fitting 68. As with the power substrate 71, a recess 81a is formed in the outer periphery of the control substrate 81. The recess 81a is formed corresponding to the position of the hole 68b of the metal fitting 68.

With the recesses 71a and 81a, the operator can operate the bolt 69 for fixing the amplifier 5 to the electric motor unit 4 from the outside of drive device 2. When detaching the amplifier 5 from the electric motor unit 4, the operator can operate the bolt 69 through the recesses 71a and 81a. By detaching the bolt 69, the amplifier 5 can be integrally detached from the electric motor unit 4 with the electric motor unit 4 fixed to the robot. Alternatively, the amplifier 5 can be attached to the electric motor unit 4 with the electric motor unit 4 fixed to the robot.

With the joint 10b of the present embodiment, the operator can operate the bolt 69 fixing the amplifier 5 to the housing 23 by detaching the lid 12ab. The operator can detach the bolt 69 through the recess 71a formed in the power substrate 71 and the recess 81a formed in the control substrate 81.

By detaching the bolt 69 by the operator, the amplifier 5 can be detached from the electric motor unit 4. The amplifier 5 can be integrally removed to the outside of the housing 12a. Then, the connector of the wire body is pulled out from the connectors 72a, 72ba, 72bb and 72c of the power substrate 71. Further, by pulling out the connector of the wire body from the connectors 82aa, 82ab, 82b and 82c arranged on the control substrate 81, the amplifier 5 can be separated from the electric motor unit 4.

In this manner, in the drive device 2 of the present embodiment, it is possible to detach only the amplifier 5 from the drive device 2 without detaching the entire drive device 2 from the robot 1. Further, the amplifier can be inspected or replaced. When attaching the amplifier 5 to the electric motor unit 4, the amplifier 5 can be fixed to the housing 23 of the electric motor unit 4 with the bolt 69 after inserting the connector of each wire body to the connector of the substrate.

Further, when detaching the drive device 2 from the housings 12a and 13a, when the amplifier 5 is detached from the drive device 2, the operator can operate the bolt 59 fixing the electric motor unit 4 to the housing 12a. The operator can detach the drive device 2 from the housings 12a and 13a by detaching the bolts 58 and 59.

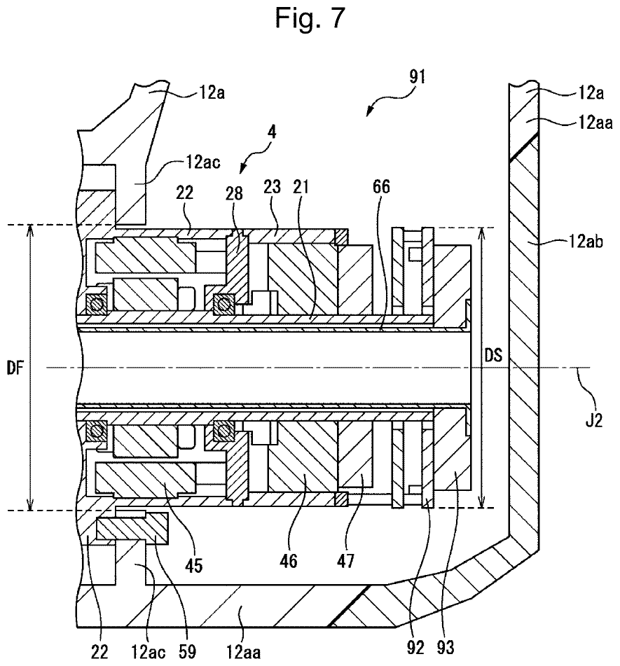

FIG. 7 is a schematic view of a drive device in a joint of a comparative example. A drive device 91 of the comparative example includes an amplifier 92. The amplifier 92 of the comparative example includes a plurality of substrates. The amplifier 92 is fixed coaxially with the electric motor unit 4 at an end portion of the electric motor unit 4.

The drive device 91 of the comparative example does not include a torque sensor. The drive device 91 includes an encoder 93 instead of the torque sensor. Two encoders 47 and 93 are arranged in the drive device 91. The encoder 47 is a primary encoder (first encoder) that detects the rotation position of the shaft 21 that is the output shaft of the electric motor 45. The encoder 93 is a secondary encoder (second encoder) that detects the rotation position of the output shaft of the electric motor unit 4. The encoder 93 detects the rotation position of a member that rotates together with the output shaft of the decelerator 31. The end surface of the protective tube 66 is connected to the encoder 93.

The robot controller can calculate the amount of torsion of the output shaft of the decelerator 31 with respect to the input shaft of the decelerator 31 (the output shaft of the electric motor 45) on the basis of the rotation position output by the encoder 47, the reduction ratio of the decelerator 31, and the rotation position output by the encoder 93. The robot controller can calculate the torque generated by the drive device 91 on the basis of the amount of torsion. Further, the external force applied to the components of the robot can be calculated on the basis of the torque of the drive device 91.

In the drive device 91 of the comparative example, the encoder 93 serving as the secondary encoder is arranged in order to calculate the torque generated by the drive device 91. The encoder 93 is arranged at the endmost of the drive device 91. In other words, the electric motor 45, the electromagnetic brake 46, the encoder 47, the amplifier 92, and the encoder 93 are arranged in this order.

Also in the drive device 91 of the comparative example, the operator can see the entire end portion of the drive device 91 by detaching the lid 12ab of the housing 12a. However, since the encoder 93 is arranged at the endmost portion of the drive device 91, it is impossible to detach only the amplifier 92 from the drive device 91. When replacing the amplifier 92, the entirety of the drive device 91 needs to be detached from the housings 12a and 13a of the robot 1.

On the other hand, with reference to FIG. 6, in the drive device 2 of the present embodiment, the torque sensor is arranged instead of the secondary encoder. The drive device 2 has a configuration that does not include the rotation position detector that detects the rotation position of the output shaft of the electric motor unit 4. The torque sensor 27 can be attached to the output shaft of the decelerator 31 or the fixing shaft of the decelerator 31. The amplifier 5 can be fixed to the end portion of the electric motor unit 4. Further, the torque sensor 27 can be arranged at an end portion on the side opposite to one end portion of the electric motor unit 4 where the amplifier 5 is arranged.

The amplifier 5 of the present embodiment is arranged at the endmost in the axial direction of the drive device 2. When replacing or inspecting the amplifier 5, the amplifier 5 can be easily detached from the electric motor unit 4 through the operator's operation. It should be noted that the drive device may include both the torque sensor and secondary encoder. In this case, it is preferable to arrange the amplifier on the outside of the secondary encoder in the axial direction of the drive device such that the amplifier is arranged at the endmost of the drive device.

With reference to FIG. 7, in the drive device 91 of the comparative example, it is impossible to remove only the amplifier 92 from the drive device 91. When replacing the amplifier 92, the drive device 91 needs to be detached from the robot. In this case, for the purpose of detaching the drive device 91 from the housing 12a of the upper arm 12, it is necessary to from an operation space around the drive device 91 such that the operator can operate the bolt 59. As such, the substrate of the amplifier 92 is formed with a small size such that an operation space is formed around the amplifier 92. In other words, the substrate of the amplifier 92 is formed in a small size such that the operator can operate the bolt 59.

For example, the substrate of the amplifier 92 can be formed such that a diameter DS is equal to or smaller than the diameter of the electric motor unit 4. Alternatively, the substrate of the amplifier 92 can be formed such that the diameter DS is equal to or smaller than an internal diameter DF of the protruding part 12ac of the housing where the bolt 69 is arranged. As such, with the drive device 91 of the comparative example, it is difficult to provide the amplifier 92 with a large diameter. As a result, the number of substrates of the amplifier may increase and the length of the amplifier in the axial direction may increase. In addition, a large number of substrates may make the structure of the amplifier complicated.

On the other hand, with reference to FIG. 6, in the drive device 2 of the present embodiment, the amplifier 5 can be detached from the drive device 2 at the beginning. In this manner, even when the bolt 59 is hidden by the substrate of the amplifier 5 and cannot be operated when the lid 12ab is detached, it suffices to detach the amplifier 5 from the drive device 2. In this manner, the size of the substrate of the amplifier 5 can be increased. In the present embodiment, the power substrate 71 and the control substrate 81 are formed such that the area of the maximum area surface of the substrate is large.

For example, the substrate of the amplifier can be formed larger than at least one selected from a group of the electric motor, the decelerator, the brake, and the rotation position detector in the radial direction. Alternatively, the substrate of the amplifier can be formed with a diameter greater than the diameter at the position of the bolt 59. Alternatively, the substrate of the amplifier can be formed with a size larger than the internal diameter of the protruding part 12ac serving as the fixing part of the housing where the bolt 59 is arranged.

In the drive device of the present embodiment, the area of the maximum area surface of the substrate where the electric component is arranged can be increased, and a large number of electric components can be arranged on a single substrate. The increase in number of substrates and the increase in size of the amplifier can be suppressed.

In the present embodiment, the amplifier 5 is fixed to the end surface of the electric motor unit 4 with the bolt 69 serving as a fastening member. With this configuration, the amplifier 5 can be easily detached from the electric motor unit 4 by detaching the bolt 69. The member for fixing the amplifier to the electric motor unit is not limited to the fastening members such as screws, bolts, and nuts, and any member may be employed. For example, a claw part is formed in one of the amplifier and the housing of the electric motor unit. An engaging part that engages with the claw part is formed at the other member. It is possible to employ a structure for fixing the amplifier to the electric motor unit by engaging the claw part with the engaging part.

The wave gear decelerator is employed as the decelerator in the present embodiment, but is not limited to this configuration. Any decelerators such as a gear decelerator may be employed. In addition, for the decelerator, it is preferable to use a decelerator that can be arranged coaxially with the electric motor with an input shaft and an output shaft arranged on the same line. For example, for the decelerator, a planetary gear decelerator may be employed.

The drive device for driving the components around the drive axis J2 of the robot is described in the present embodiment, but this embodiment is not limitative. The drive device of the present embodiment may be employed for a drive device for driving a given component of the robot.

In addition, the drive device of the robot of the present embodiment is arranged at the joint, but is not limited to this configuration. The drive device of the present embodiment is applicable to any devices for relatively rotating two different members around the rotation axis. For example, the drive device of the present embodiment is applicable to a drive device for driving the wheel of an unmanned vehicle, a drive device arranged in an operation tool so as to drive the components of the operation tool, a drive device of an automatic tool replacement device of a machine tool, or the like.

The above embodiments can be combined as appropriate. In each of the above-described drawings, the same or equivalent parts are denoted by the same sign. The above embodiments are examples and do not limit the invention. In addition, the embodiments include the modifications of the embodiments defined in the claims.

1. A drive device comprising:
an electric motor unit including an electric motor; and
an electric motor control unit configured to supply a current to the electric motor, wherein
the electric motor unit includes at least one device selected from a group of a decelerator, a brake, and a rotation position detector,
the electric motor control unit includes a substrate and a plurality of electric components fixed to the substrate, and
the electric motor control unit is coaxially fixed to an end portion of the electric motor unit in a direction of a rotation axis of the electric motor, and is formed so as to be detachable from the electric motor unit through an operation by an operator.

2. The drive device of claim 1, wherein the electric motor control unit is fixed to the end portion of the electric motor unit with a fastening member.

3. The drive device of claim 1, comprising a wire body for connecting to an external device, wherein
the wire body includes a connecting member for connecting to the substrate, and
the connecting member is formed so as to be attached to a member of the substrate or detached from the member of the substrate.

4. The drive device of claim 3, wherein the connecting member includes a connector or a crimp terminal.

5. The drive device of claim 1, wherein the substrate is formed larger than at least one device selected from a group of the electric motor, the decelerator, the brake, and the rotation position detector in a radial direction.

6. The drive device of claim 1, comprising a torque sensor configured to detect a torque output from the electric motor unit, wherein the torque sensor is arranged at an end portion on a side opposite to one end portion of the electric motor unit at which the electric motor control unit is arranged.

7. The drive device of claim 1, wherein the electric motor unit has a configuration including a rotation position detector configured to detect a rotation position of an output shaft of the electric motor and not including a rotation position detector configured to detect a rotation position of an output shaft of the electric motor unit.

8. The drive device of claim 1, wherein the electric motor control unit is arranged for each electric motor.

9. A robot comprising:
the drive device of claim 1; and
a joint configured to rotate one component of the robot with respect to another component of the robot, wherein
the drive device is arranged at the joint.
